(19) United States
(12) Patent Application Publication
(10) Pub. No.: US 2002/0142803 A1
(43) Pub. Date: Oct. 3, 2002

(54) Mobile communication terminal and car mounted electronic device

(76) Inventor: Toshifumi Yamamoto, Shiroyamamachi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/926,434

(22) PCT Filed: Mar. 2, 2001
(86) PCT No.: PCT/JP01/01648

(30) Foreign Application Priority Data
Mar. 2, 2000 (JP) 2000-057244

(51) Int. Cl. H04M 1/00

(52) U.S. Cl. 455/557; 455/456; 455/41

(57) ABSTRACT

BT wiring sections 40 and 6 are provided respectively at a mobile telephone set MS and a car audio device AS. When a user of the mobile telephone set MS gets on a car CR, a BT radio link is established between the mobile telephone set MS and the car audio device AS, and a hands-free communication mode is set to the mobile telephone set MS and car audio device AS. Then, the communication speech data received from/transmitted to a mobile communication network via a W-CDMA radio link is transferred between the mobile telephone set MS and the car audio device AS, thereby enabling hands-free communication.

### TECHNICAL FIELD

The present invention pertains to a mobile communication terminal such as mobile telephone set or cordless telephone set, for example. In particular, the present invention relates to a car mounted electronic device such as a mobile communication terminal connectable to a car audio device or car navigation, car telephone set and the like and a car mounted electronic device that makes this mobile communication terminal connectable.

### BACKGROUND ART

In recent years, a mobile communication terminal such as mobile telephone set or cordless telephone set is rapidly more popular. Although a terminal of such type is mainly used at an exterior or at an interior lobby, it may be used in car such as private car or commercially available car. In this case, it is very dangerous for a driver to make a phone call while holding a terminal during driving from a viewpoint of traffic safety.

Conventionally, a specific car kit having a microphone and a speaker is installed on a dashboard or the like. Then, a terminal is mounted on a placement base of this car kit, whereby the terminal can be used as a car telephone device. When this car kit is employed, a driver can make a phone call by its hands-free talk function without holding a terminal.

However, in order to achieve this hands-free talk, a user must purchase the car kit, and is forced to burden a cost for that purpose. In addition, even if the user purchases the car kit, in the case where there is no adequate space for installing the car kit in car, installation itself may be difficult.

### DISCLOSURE OF INVENTION

It is an object of the present invention to provide a mobile communication terminal and a car mounted electronic device that enable hands-free communication without requiring a specific car kit, thereby enabling mobile communication in car at a low cost without providing a new installation space.

That is, in the latest, there is an increased number of vehicles having a car mounted device such as car audio device or car navigation device installed therein. A speaker or a display section is generally provided at each of these car mounted electronic devices, and a microphone or a camera is provided.

According to the present invention, in view of the foregoing point, an existing car mounted electronic device is utilized, and a radio interface such as BT (Bluetooth) system is used, whereby hands-free mobile communication can be made at a low cost and easily without newly purchasing and installing a specific car kit.

For example, according to a first aspect of the present invention, there is provided a mobile communication terminal communicatable with a car mounted electronic device, further comprising: a first radio interface for making radio communication with a mobile communication network via a first radio channel; a second radio interface for making radio communication with a car mounted electronic device via a second radio channel; and a reception data transfer control function. With the reception data transfer control function, reception information data received from a mobile communication network via the first radio channel is transferred to the car mounted electronic device via the second radio channel so as to be outputted from the information output means of the car mounted electronic device.

Therefore, according to the first aspect of the present invention, the mobile communication terminal is communicatable with the car mounted electronic device via the second radio channel of small power type. In this situation, when speech data of a communication party or home page data is downloaded from the mobile communication network via the first radio channel, the reception data is transferred to the car mounted electronic device via the second radio channel after the data has been received by the mobile communication terminal, and then, is outputted by the speaker or display section provided at this car mounted electronic device.

Thus, a user may not newly purchase and install a specific car kit. Therefore, the user's burden on the cost is reduced, and an installation space for such car kit is eliminated. Moreover, while the mobile communication terminal is housed in a pocket of the user's cloth or in a bag, information data can be received in a hands-free mode without making any operation. Thus, cable connection work is eliminated, and everyone can make hands-free mobile communication easily.

In addition, according to a second aspect of the present invention, there is provided the mobile communication terminal communicatable with the car mounted electronic device including information input means having at least one of a microphone and a camera, comprising: a first radio interface for making radio communication with a mobile communication network via a first radio channel; a second radio interface for making radio communication with a car mounted electronic device via the second radio channel; and a transmission data transfer control function. With this transmission data transfer control function, transmission information data inputted by information input means of the car mounted electronic device is received from the car mounted electronic device via the second radio channel so as to be transmitted to a mobile communication network via the first radio channel.

Therefore, according to the second aspect of the present invention, a mobile communication terminal is connected to a car mounted electronic device via the second radio channel. In this situation, in a microphone or a camera of the car mounted electronic device, for example, when the user talk voice or face video is inputted, the thus inputted transmission data is transmitted from this mobile communication terminal to the mobile communication network via the first radio channel after the data has been transferred to the mobile communication terminal via the second radio channel.

Therefore, in the second aspect of the present invention as well, as in the first aspect of the present invention, the user may not newly purchase and install a specific car kit. Moreover, while the mobile communication terminal is housed in a pocket of the user's cloth or in a bag, information data can be transmitted in a hands-free mode without making any operation.

According to the first and second aspects of the present invention, when reception information data is transferred to the car mounted electronic device or when transmission information data is received from the car mounted electronic device, an output operation restraining command is supplied from the mobile communication terminal to the car mounted electronic device via the second radio channel or the car mounted electronic device itself detects a transfer of the information data, thereby restraining an output of information specific to the car mounted electronic device caused by information output means.

By doing this, for example, in a car audio device, in the case where a music reproduced from a radio reception program or CD and the like is outputted from a speaker, its output level is restrained to a level such that an output of the reception information data transferred from the mobile communication terminal is not interfered. In addition, in a car navigation device, a map or the like is displayed at a display section, the above map or the like is displayed to be interrupted or reduced so as not to interfere the display of video data transferred from the mobile communication terminal. Therefore, the reception information data transferred from the mobile communication terminal can be reliably outputted without being interfered with operation specific to the car mounted electronic device.

Further, according to the first and second aspects of the present invention, there are provided an entry detecting function for detecting an entry of a mobile communication terminal relevant to a radio area for the second radio channel formed by the car mounted electronic device and a radio automatic connection control function, wherein the car mounted electronic device and mobile communication terminal are connected to each other via a communication link caused by the second radio channel according to the fact that the entry detecting function has detected an entry of the mobile communication terminal, further enabling a transfer of information data between the mobile communication terminal and the car mounted electronic device.

By doing this, if the mobile communication terminal makes an entry into the radio area of the car mounted electronic device, this entry is detected by the car mounted electronic device or mobile communication terminal itself. Then, a communication link caused by the second radio channel is automatically established between the car mounted electronic device and the mobile communication terminal itself. Therefore, the user may not perform operation or settings for connecting a serial mobile communication terminal to the car mounted electronic device every time the user gets on a car. Thus, even if a user is unfamiliar with operation, the user can use the device easily.

Further, the present invention comprises a withdrawal detecting function for detecting the fact that the mobile communication terminal has been withdrawn from the radio area for the car mounted electronic device; and a radio automatic disconnection control function, wherein, in the case where the withdrawal detecting function detects the fact that the mobile communication terminal has withdrawn from the radio area, a communication link is disconnected by the second radio channel between the car mounted electronic device and the mobile communication terminal.

By doing this, in the case where the user gets out of the car with mobile communication terminal, a communication link caused by the second radio channel, which has been established between the mobile communication terminal and the car mounted electronic device, is automatically disconnected so that the mobile communication terminal can be automatically restored to a sole operating mode. In addition, the car mounted electronic device can be automatically restored to an operating mode that precedes its own specific operation.

Further, in a car mounted electronic device, in the case where the entry detecting means has detected an entry of the mobile communication terminal into the radio area caused by the second radio channel, connection with the mobile communication terminal is established via the second radio channel, and authentication procedures are executed between the car mounted electronic device and the mobile communication terminal. In the case where it is determined that the mobile communication terminal is not registered in advance by this authentication, the opening of the vehicle door or engine startup is disabled.

By doing this, the vehicle can be safeguarded by utilizing an authentication function during radio communication between the mobile communication terminal and the car mounted electronic device.

### BRIEF DESCRIPTION OF DRAWINGS

FIG. 1 is a schematic view illustrating a first embodiment of a car mounted radio system using a mobile telephone set and a car audio device according to the present invention;

FIG. 2 is a block diagram depicting a configuration of a mobile telephone set of the system shown in FIG. 1;

FIG. 3 is a circuit block diagram depicting a configuration of a car audio device used in the system shown in FIG. 1;

FIG. 4 is a sequence diagram showing procedures for establishing a BT radio link executed between the mobile telephone set and the car audio device

FIG. 5 is a sequence view showing procedures executed between the mobile telephone set and the car audio device on incoming call;

FIG. 6 is a sequence diagram showing procedures executed between the mobile telephone set and the car audio device on outgoing call;

FIG. 7 is a sequence diagram showing procedures executed between the mobile telephone set and the car navigation device on incoming call; and

FIG. 8 is a sequence diagram showing procedures executed between the mobile telephone set and the car navigation device on outgoing call.

### BEST MODE FOR CARRYING OUT OF THE INVENTION

(First embodiment)

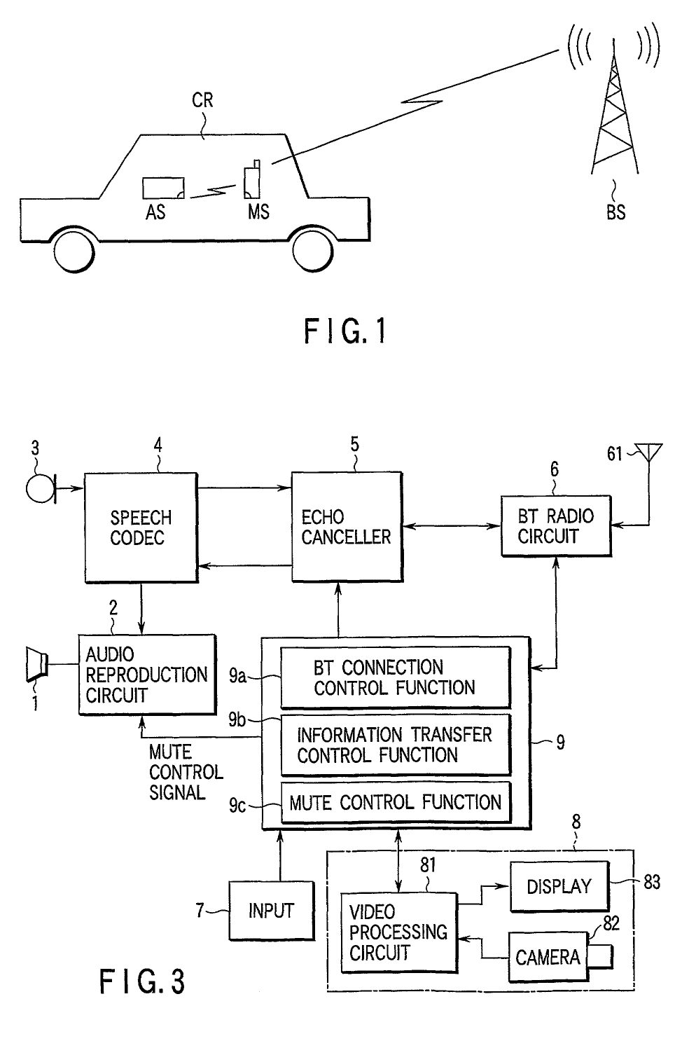

FIG. 1 is a schematic view illustrating a first embodiment of a car mounted radio system using a mobile communication terminal and a car mounted electronic device according to the present invention. In the figure, MS denotes a mobile telephone set that is a mobile communication terminal, and AS denotes a car audio device that is a car mounted electronic device.

First, the mobile telephone set MS comprises: a first radio communication function using a W-CDMA (Wideband-Code Division Multiple Access) scheme; and a second radio communication function using a BT (Bluetooth) scheme.

The W-CDMA scheme enables large-capacity multimedia mobile communication at a high speed by using a 5-MHz bandwidth, for example, in a 2 GHz band. This scheme makes radio communication after synchronization caused by code spreading has been established with one of a plurality of base stations (BS) distributed in a service area. A CDMA scheme is used as a radio access scheme between the base station BS and the mobile telephone set MS. In addition, three schemes, i.e., DS-FDD (Direct Sequence-Frequency Division Duplex), MS-FDD (Multi Carrier-Frequency Division Duplex), and TDD (Time Division Duplex) are selectively used for upstream and downstream directions.

In contrast, the BT scheme makes radio communication within a short distance of 10 m or less with a finely weak electronic wave of 10 mW (a maximum of 100 mW) by utilizing a 2.4 GHx bandwidth ISM band. This scheme is used as a scheme for making radio connection between a personal computer and a peripheral device such as printer or between a mobile telephone set MS and a notebook type personal computer PC. In the BT scheme, a radio transmission system employing a frequency hopping system is used so as to enable operation even in environment containing much noise. A hop frequency of the frequency hopping is set to 1600 hops/second, for example. In addition, radio communication with a communication party by means of an asynchronous channel is enabled, and the entire transfer rate is 1 Mbps.

Further, 8 devices can be connected at most within a use range of 10 m or less. These devices form a network called Piconet. One of them functions as a master, and the others function as a slave. In the device in the Piconet, connection authentication is performed through a password called PIN (Personal Identification Number) code.

Next, a car audio device AS has a function for outputting music broadcast received by a tuner or music reproduced from a semiconductor memory such as CD, MD, flash EEPROM and the like. In addition to this specific function, this device comprises a radio communication function and a function for enabling a hands-free talk using the BT (Bluetooth) scheme.

The BT radio communication function defines a limited peripheral region in or outside a car as a radio area, and establishes a radio link with a mobile telephone set MS that has entered this radio area by means of the BT radio communication protocol, thereby making radio communication.

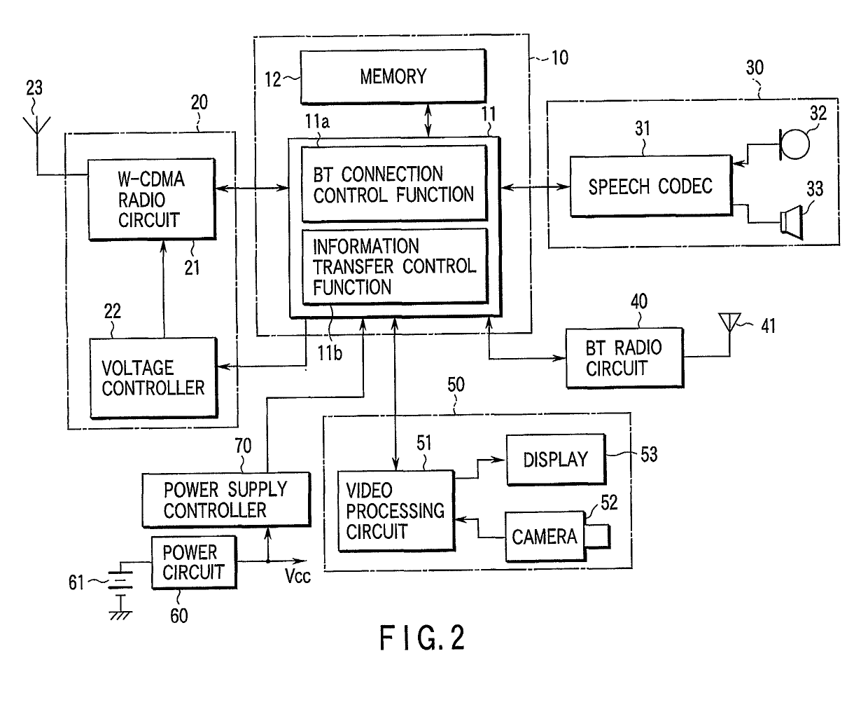

In the meantime, the mobile telephone set MS and car audio device AS are respectively configured as follows, for example. FIG. 2 is a block diagram depicting a configuration of the mobile telephone set MS. FIG. 3 is a block diagram depicting a configuration of a car audio device AS.

First, the mobile telephone set MS comprises a control unit 10; a W-CDMA radio unit 20; and a communication unit 30. The MS further comprises a BT radio section 40; a video processing unit 50; a power circuit 60; and a power supply control section 70.

The W-CDMA radio unit 20 comprises a W-CDMA radio section 21 and a voltage control section 22. The W-CDMA radio section 21 receives/transmits a CDMA signal from/to a base station BS via an antenna 23 in accordance with a W-CDMA scheme. The code spreading chip rate is set to 4.096 Mcps, and a QPSK scheme is used for a primary modulation system. The voltage control section 22 controls a transmission level of a CDMA signal transmitted by the W-CDMA radio section 21 in accordance with a command from a main control circuit 11.

The communication unit 30 comprises a speech CODEC section 31; a microphone 32; and a speaker 33. The speech CODEC section 31 encodes a transmission speech signal inputted from the microphone 32 in accordance with a predetermined voice encoding scheme. In addition, a reception signal inputted from the W-CDMA radio section 21 via the main control circuit 11 is decoded and converted into a reception speech signal. Then, the converted signal is loudly outputted from a receiver 33.

The BT radio section 40 receives/transmits a radio signal from/to the car audio device AS in accordance with the BT scheme. Reference numeral 41 denotes an antenna used for receiving/transmitting a radio signal in accordance with this BT scheme.

The video processing unit 50 comprises: an video processing section 51; a camera 52 employing a charged coupler device such as CCD or CMOS; and a display section 53 using a liquid crystal device (LCD). The video processing section 51 is used for television telephone communication or, video data communication and the like. This section applies encode processing such as encoding to an video signal acquired by the camera 52, and the encoding video data is inputted to the control unit 10. In addition, reception video data or video data stored in a memory 12 is subjected to decode processing, and the decoded data is displayed on the display section 53.

A power circuit 60 generates an operating voltage Vcc required for operating each circuit in the mobile telephone set MS based on an output voltage of a battery 61.

A power supply control section 70 has a battery saving function. This section supplies the operating voltage Vcc to each circuit in the mobile telephone set MS at each optimal timing.

The control unit 10 comprises: a main control circuit 11 using a microcomputer: and a memory 12. At this memory 12, there are provided: a program storage region; a control data storage region; and reception/transmission data storage region. A program required for control operation of the main control circuit 11 is stored in advance in the program storage region. Control data required for execution of the above program, communication paert's telephone directory data and the like are stored in the control data storage region. Data to be transmitted by the W-CDMA scheme and BT scheme or received data is stored in the reception/transmission data storage region.

The main control circuit 11 comprises: a control function for making radio communication with a mobile communication network employing the W-CDMA scheme and new functions according to the present invention, i.e., a BT connection control function 11a and an information transfer control function 11b.

In the case where a mobile telephone set MS itself enters a BT radio area formed by a car audio device AS, the BT connection control function 11a executes procedures for establishing a BT radio link with the car audio device AS. Then, after the BT radio link has been established, this function sets an operating mode of the mobile telephone set MS to a hands-free mode. Furthermore, in the case where the mobile telephone set MS is out of the radio area for the car audio device AS, it executes procedures for disconnecting the BT radio link. Then, after the radio link has been disconnected, the operating mode of the mobile telephone set MS is reset to a single mode to set the hands-free communication operating mode.

The information transfer control function 11b controls transfer of an incoming/outgoing call control signal between the mobile communication network and the car audio device AS and transfer of speech data and video data, respectively, while a BT radio link with the car audio device AS is established by the BT connection control function 11a.

The car audio device AS comprises: a speaker 1; an audio reproduction section 2; a hands-free communication section; an video processing unit 8; a BT radio section 6; a control section 9; and an input section 7.

The audio reproduction section 2 reproduces a music broadcast received by a tuber (not shown) or audio data recorded in a CD, a MD or a flash memory, and loudly outputs it from the speaker 1.

The hands-free communication section consists of a microphone 3, a speech CODEC 4; and an echo canceller 5. Reception speech data supplied from the BT radio section 6 described later is inputted to the speech CODEC section 4 via the echo canceller 5. The speech CODEC section 4 performs a predetermined speech decode processing for the reception speech data, and reproduces a reception speech signal. This reception speech signal is supplied to the speaker 1 via the audio reproduction section 2, and is loudly outputted from this speaker 1.

The hands-free communication section encodes a transmission speech signal inputted to the microphone 3 at the speech CODEC section 4 in accordance with a predetermined speech encoding scheme, and inputs the encoded transmission speech data to the echo canceller 5. The echo canceller 5 generates a pseudo echo adaptively based on the reception speech data. Then, this pseudo echo is subtracted from the transmission speech data, thereby canceling an acoustic echo component included in the transmission speech data.

The BT radio section 6 receives reception speech data transferred from the mobile telephone set MS in a radio manner in accordance with the BT scheme at the hands-free mode, and inputs the data to the echo canceller 5. In addition, the transmission speech data outputted from the echo canceller 5 is transmitted to the mobile telephone set MS in a radio manner. Reference numeral 61 denotes an antenna for receiving/transmitting a radio signal in accordance with this BT scheme.

The video processing unit 8 is intended for television telephone communication, video data communication and the like. This unit comprises a video processing section 81, a camera 82 employing a charged coupler device such as CCD or CMOS; and a display section 83 using a liquid crystal device (LCD).

The video processing section 81 encodes a video signal acquired by the camera 82, and supplies the signal to the control unit 9. In addition, the reception video data outputted from the control unit 9 is subjected to decode processing, and the decoded data is displayed at the display section 83.

The control unit 9 integrally controls operation of the entire car audio device AS. This unit further comprises: a BT connection control function 9a; an information transfer control function 9b; and a mute control function 9c as well as a control function according to the above audio reproduction.

The BT connection control function 9a supervises an entry of the mobile telephone set MS into its own BT radio area by means of the BT radio section 6. In the case where it is detected that the mobile telephone set MS enters its own BT radio area, this function executes procedures for establishing a BT radio link with the mobile telephone set MS. In addition, after the BT radio link has been established, it sets an operating mode of the car audio device AS to a hands-free mode.

On the other hand, in the case where it is detected that the mobile telephone set MS is out of its own radio area, the above control function executes procedures for disconnecting a BT radio link. After the radio link has been disconnected, its own operating mode is reset to a single mode for performing only audio reproduction.

The information transfer control function 9b receives/transmits a variety of control data according to incoming and outgoing calls between the BT radio link and the mobile telephone set MS via the BT radio link while the BT radio link with the mobile telephone set MS is established by the BT connection control function 9a. In addition, in the case where a hands-free communication operation is started, reception/transmission speech data and video data are received/transmitted from/to the mobile telephone set MS.

The mute control function 9c determines whether or not audio reproduction operation is performed at the audio reproduction section 2 prior to start of hands-free communication. If audio reproduction is in progress, this function supplies a mute control signal to the audio reproduction section 2 to suspend audio reproduction or reduce the output volume to a predetermined level or less.

Now, an operation of the above configured mobile telephone set MS and car audio device AS will be described here.

The mobile telephone set MS sets its own operating mode to a single communication mode if the mobile telephone is outside a car. Therefore, in this situation, if a user performs call origination operation or an incoming call comes from a mobile communication network, the mobile telephone set MS establishes a radio link with the base station BS of the mobile communication network in accordance with the W-CDMA scheme, and makes communication for talking or television telephone.

In addition, the car audio device AS periodically transmits an IQ packet for inquiry from a BT radio section 40 in a wait state. This IQ packet transmission is intended for detecting an entry of the mobile telephone set MS into a BT radio area formed by the car audio device AS.

In this situation, assume that a user of the mobile telephone set MS gets on its own car CR. Then, an IQ packet transmitted by the car audio device AS is received by the mobile telephone set MS. When this IQ packet is received, the mobile telephone set MS transmits an FHS packet to the car audio device AS. Into this FHS packet, there is inserted data representing an attribute of the mobile telephone set MS, for example, information representing a Bluetooth address and a Bluetooth clock.

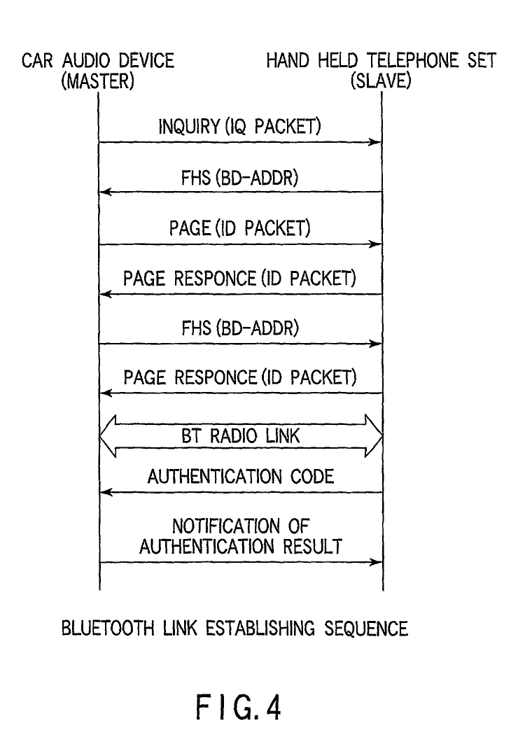

When the above FHS packet is received, the car audio device AS determines that the mobile telephone set MS enters its own BT radio area. Then, this device executes connection procedures for establishing asynchronous connection-less link (ACL) with the mobile telephone set MS. FIG. 4 shows the connection procedures.

That is, the car audio device AS first transmits an ID packet for page to the mobile telephone set MS based on information on the FHS packet received from the mobile telephone set MS. When the car audio device receives an ID packet for page response from the mobile telephone set MS to transmission of this ID packet, then it transmits an FHS packet.

The FHS message includes a synchronous word, an ID address, and a MAC address. The synchronous word is generated based on an address of the car audio device AS that is a master. The ID address is a unique address “BD-ADDR” in this Piconet, assigned to the BT radio section 6 of the car audio device AS. This address is composed of an “LAP field” (least significant address), an “UAP address” (significant address), and an NAP address (additional address). The MAC address is a physical address of the mobile telephone set MS.

When the above FHS packet is received, the mobile telephone set MS returns an ID packet for page response, thereby establishing connection. In this way, an ACL link is established between the mobile telephone set MS and the car audio device AS.

When the ACL link is established, the mobile telephone set MS transmits a pre-registered authentication code to the car audio device AS. When the above authentication code is received, the car audio device AS determines whether or not this authentication code is a pre-registered code. When it is determined that such authentication code is a pre-registered code, the car audio device AS notifies the authentication result to the mobile telephone set MS. In this way, the mobile telephone set MS enables radio communication with the car audio device AS.

In addition, at this time, the mobile telephone set MS switches its own communication mode from a single mode to a hands-free mode for making communication using the car audio device AS. Alternatively, the car audio device AS switches its own operating mode from an audio reproduction mode to a hands-free mode.

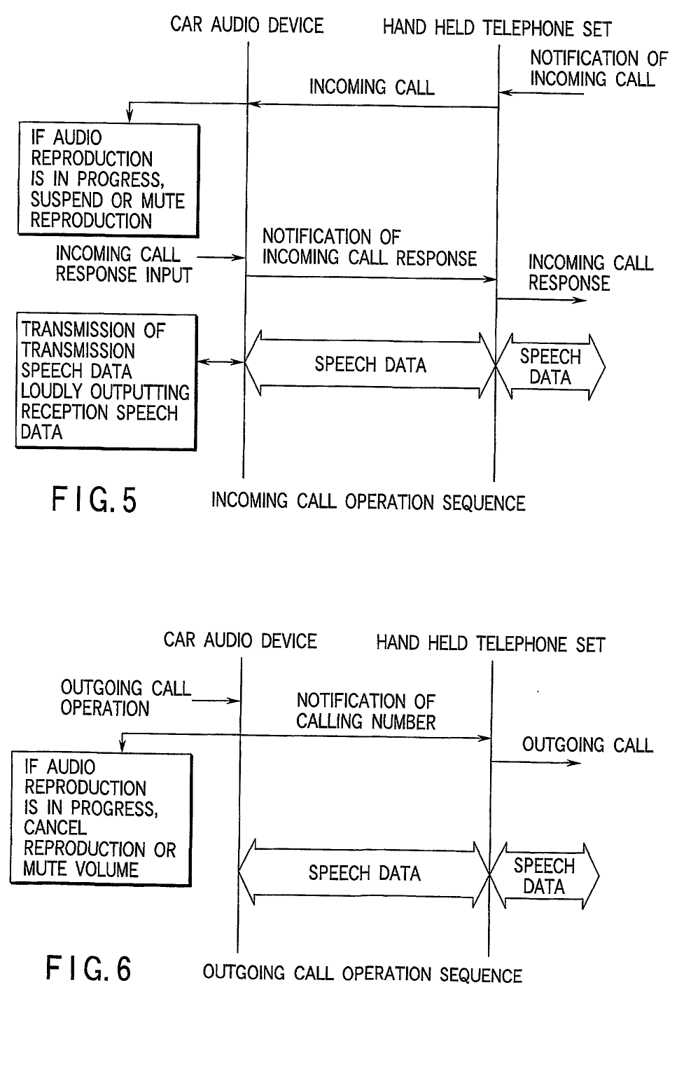

In a state in which this hands-free mode is set, assume that an incoming call comes from a mobile communication network. In this case, the mobile telephone set MS transmits incoming call notification information to the car audio device AS via an ACL link, as shown in FIG. 5. When incoming call notification information comes from the mobile telephone set MS, the car audio device AS determines whether or not audio reproduction is in progress. As a result of this determination, if audio reproduction is in progress, a control unit 9 supplies a mute control signal to an audio reproduction section 2, thereby suspending audio reproduction operation or muting or reducing a volume.

In response to the above incoming call notification, assume that a user press an incoming call response switch of the car audio device AS or inputs a voice message that an incoming call response is made by utilizing a speech recognition function of the car audio device AS. In this case, notification information on an incoming call response is returned from the car audio device AS to the mobile telephone set MS via the BT radio link. When the notification information on an incoming call response reaches, the mobile telephone set MS returns an incoming call response from the W-CDMA radio section 21 to the mobile communication network. In this way, a connection between the mobile communication network and the mobile telephone set MS is established by a radio link using the W-CDMA scheme, further enabling communication with a party terminal connected to the mobile communication network.

In this communication state, the reception speech data transmitted from the party terminal via the W-CDMA radio link is transferred to the BT radio section 40 via the main control circuit 11 after the data has been received by the W-CDMA radio section 21 via the mobile telephone set MS, and is transferred from this BT radio section 40 to the car audio device AS via the BT radio link. In the car audio device AS, when the above reception speech data is received by the BT radio section 6, this reception speech data is inputted to the speech CODEC section 4 via the echo canceller 5, is decoded by this speech CODEC section 4, and then, reproduced by the audio reproduction section 2 to be loudly outputted from the speaker 1.

In contrast, the user's transmission speech is inputted to the microphone 3 of the car audio device AS, and is encoded by the speech CODEC section 4. Then, an acoustic echo component is cancelled by the echo canceller 5, and then, transferred from the BT radio section 6 to the mobile telephone set MS via the BT radio link. This transmission speech data is inputted to the W-CDMA radio section 21 via the main control circuit 10 after the data has been received by the BT radio section 40 of the mobile telephone set MS, and is transmitted from this W-CDMA radio section 21 to the base station BS of the mobile communication network.

On the other hand, in a wait state, assume that the user operates an off-hook key and a dial key of the car audio device AS. In this case, the control unit 9 of the car audio device AS determines whether or not audio reproduction is in progress, as shown in FIG. 6. When audio reproduction is in progress, the control unit 9 supplies a mute control signal to the audio reproduction section 2, thereby suspending audio reproduction operation or muting or reducing a volume.

In the case where an attempt is made to originate a call by utilizing the voice recognition function of the car audio device AS, a mute key provided at the car audio device AS is operated or a call origination ready key is operated. By doing this, the control unit 9 determines whether or not audio reproduction is in progress. As a result of this determination, if audio reproduction is in progress, the control unit 9 supplies a mute control signal to the audio reproduction section 2, thereby suspending audio reproduction operation or muting or reducing a volume. Then, in this state, the user voice inputs a dial number of a party terminal, and further, voice inputs outgoing call.

As described above, in the car audio device AS, when outgoing call operation is made, the inputted dial number is encoded. Then, the notification information on this encoded dial number is transferred from the BT radio section 6 to the mobile telephone set MS via the BT radio link. When the notification information on a dial number comes from the car audio device AS via the BT radio link, the mobile telephone set MS transmits outgoing call data from the W-CDMA radio section 21 to the mobile communication network. In contrast, when a terminal at the called party side responds to such incoming call, a connection between the mobile communication network and the mobile telephone set MS is established by a radio link using the W-CDMA scheme, enabling communication with the party terminal.

In the case where a dial number is voice inputted, a voice signal of the inputted dial number is transferred intact to the mobile telephone set MS via the BT radio link without encoding the signal, and speech recognized by the mobile telephone set MS so as to be converted into code data on the dial number.

Transfer operation of speech data between the mobile telephone set MS and the car audio device AS in a communication enable state is similar to the case of incoming call described previously.

On the other hand, assume that the user get off from a car CR while holding the mobile telephone set MS, and is out of the BT radio area formed by the car audio device AS. In this case, the car audio device AS and the mobile telephone set MS detect withdrawal of this mobile telephone set MS from the BT radio area, and perform processing for disconnecting the BT radio link.

That is, in a state in which the BT radio link is established or in a state in which the current mode is switched to a low power consumption mode, the car audio device AS and the mobile telephone set MS periodically receives and transmits a packet. For example, every time a packet is received, a link supervision timer is reset, and a time for reception of a next packet to be sent from the party side is monitored. Even if the link supervision timer exceeds the limit, when no packet can be received, the car audio device AS or the mobile telephone set MS assumes the party side as a communication disable, transmits a control packet for disconnecting a BT radio link, and terminates the BT radio link.

Therefore, if the mobile telephone set MS is distant from its own vehicle for a predetermined time or more, the BT radio link is automatically disconnected.

In addition, at this time, the mobile telephone set MS restores its own communication operating mode from a hands-free mode for making communication using the car audio device AS to a single mode. Alternatively, the car audio device AS restores its own operating mode from a hands-free mode to an audio reproduction mode.

As has been described above, in the first embodiment, the BT radio sections 40 and 6 are provided respectively at the mobile telephone set MS and the car audio device AS. When the use of the mobile telephone set MS gets on the car CR, the BT radio ink is established between the mobile telephone set MS and the car audio device AS, and the hands-free mode is set at the mobile telephone set MS and the car audio device AS. Then, the speech data received/transmitted from/to the mobile communication network via the W-CDMA radio link is transferred between the mobile telephone set MS and the car audio device AS, enabling hands-free communication.

Therefore, the user can make hands-free communication by utilizing the existing car audio device AS, thereby enabling hands-free communication in the car inexpensively without newly providing a specific car kit. In addition, there is no need to connect its own mobile telephone set MS to the car audio device AS via a cable or attach it to a terminal. Thus, the user can make hands-free communication while the mobile telephone set MS is housed in a pocket of the user's cloth or in a bag.

In addition, at the time of outgoing call or incoming call, in the car audio device AS, it is determined whether or not audio reproduction is in progress. In the case where audio reproduction is in progress, an audio reproduction output is automatically muted. Therefore, there is no concern that hands-free communication is interfered with such audio reproduction output.

Further, the car audio device executes procedures for detecting an entry of the mobile telephone set MS into the BT radio area of the car audio device AS, and, with this being a trigger, establishing a BT radio link between the mobile telephone set MS and the car audio device AS. This makes it possible to automatically establish the BT radio link. Therefore, the user of the mobile telephone set MS may not perform operation or setting for forming the BT radio link.

Furthermore, in the case where it is detected that the mobile telephone set MS is withdrawn from the BT radio area, and this withdrawal is detected, the BT radio link between the car audio device AS and the mobile telephone set MS is disconnected, and operation modes for the car audio device AS and the mobile telephone set MS are restored to a single operating mode.

Therefore, processing for disconnecting the BT radio link and restoring a communication mode can be automatically performed. Thus, even in the case where the user gets out of the car CR while holding the mobile telephone set MS, it is unnecessary to perform operation for restoring the communication operating mode of its own mobile telephone set MS and car audio device AS to a single mode.

As a technique for detecting the withdrawal of the mobile telephone set MS from the BT radio area of the car audio device AS, there can be used a technique for the mobile telephone set MS to periodically transmit an access signal to the BT radio link, and then, supervising the presence or absence of a response from the car audio device AS to such access signal.

(Second Embodiment)

According to a second embodiment of the present invention, a mobile telephone set MS is connected to a car navigation device comprising a microphone and a speaker via a BT radio interface, thereby enabling television telephone communication during a hands-free mode.

The car navigation device comprises: a function for measuring a current position of its own vehicle by utilizing a GPS (Global Positioning System); a function for displaying the thus measured current position at a display section together with map information; a hands-free communication function; a display control function for displaying a video for television telephone communication at the display section; and a BT interface for making radio communication with the mobile telephone set MS.

Among them, the display control function determines the current position and map information measured by the GPS system, namely, whether or not GPS information display operation is performed prior to the startup of the hands-free communication. If the information is being displayed, GPS information display operation is suspended or its display region is reduced. In this state, reception video data transferred by radio from the mobile telephone set MS via the BT interface is displayed at the display section.

The hands-free communication function is achieved by a speaker 1, an audio reproduction section 2, a microphone 3, a speech CODEC section 4, and an echo canceller 5, as in the first embodiment. The BT interface is composed of a BT radio section 6 and a BT connection control function 9a.

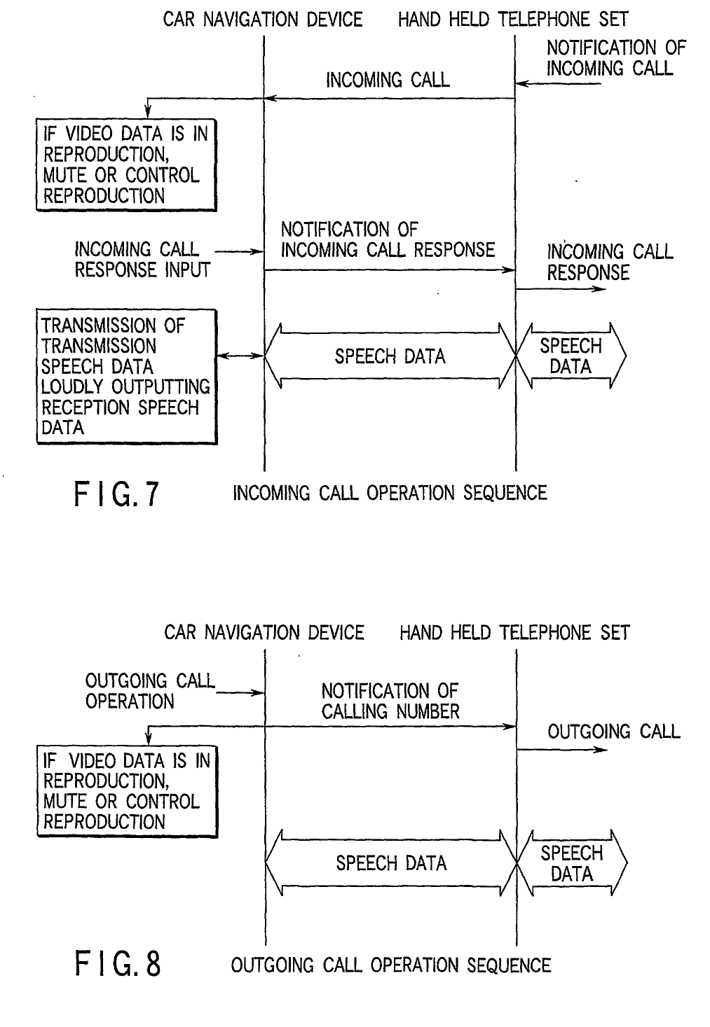

With such configuration, assume that an incoming signal comes from a mobile communication network while a hands-free mode is set. In this case, the mobile telephone set MS transfers control data for notifying the above incoming call to a car navigation device via the BT radio link, as shown in FIG. 7. When control data for notifying an incoming call comes from the mobile telephone set MS, the car navigation device determines whether or not GPS information is being displayed. If the car navigation device determines that the GPS information indispensable to car navigation (e.g., road map), the displaying of the GPS information is interrupted and the data transmitted from the mobile telephone is displayed instead. Alternatively, the region displaying the GPS information is reduced and the data sent from the mobile telephone is displayed in the remaining area of the screen. Thus, the data from the mobile telephone is displayed prior to the GPS information in the car navigation device.

In response to notification of the above incoming call, assume that the user presses an incoming call response switch provided at the car navigation device or inputs a voice message indicating that an incoming call response is made by utilizing the voice recognition function of the car navigation device. In this case, control data for notifying an incoming call response from the car navigation device to the mobile telephone set via a BT radio link is transmitted. When the mobile telephone set MS receives the control data for notifying the incoming call response, the W-CDMA radio section transmits an incoming call response signal to the mobile communication network. In this way, a connection between the mobile communication network and the mobile telephone set MS is established by a radio link using the W-CDMA scheme. Then, the mobile telephone set MS enables television telephone communication with the party terminal connected to the mobile communication network.

In this communication state, the reception speech data transmitted from the party terminal via the W-CDMA radio link is transferred to the BT radio section via the main control circuit after the data has been received by the W-CDMA radio section, and is transferred from this BT radio section to the car navigation device via the BT radio link.

When the above reception speech data is received by the BT radio section, the car navigation device inputs the reception speech data to the speech CODEC section via the echo canceller, and decodes the data at this speech CODEC section. Then, the decoded reception speech data is reproduced at the audio reproduction section, and is loudly outputted from the speaker.

In contrast, the user's transmission voice is inputted to the microphone of the car navigation device, and is encoded by the speech CODEC section. Then, an acoustic echo component is cancelled by the echo canceller. Then, the echo cancelled speech signal is transmitted from the BT radio section to the mobile telephone set MS via the BT radio link. Then, the transmission speech data is inputted to the W-CDMA radio section via the main control circuit after the data has been received by the BT radio section of the mobile telephone set MS, and is transmitted from this W-CDMA radio section to a base station BS of a mobile communication network.

On the other hand, in a wait state, assume that the user operates a call origination key and a dial key provided at the car navigation device. In this case, a control unit of the car navigation device determines whether or not GPS information is being displayed, as shown in FIG. 8. If the GPS information is being displayed, display operation of the GPS information is suspended or a display region is reduced.

In the case where a call is originated by utilizing a voice authentication function of the car navigation device, a mute key provided at the car navigation device is operated or a call origination ready key is operated. By doing this, the control unit determines whether or not GPS information is being displayed. As a result of this determination, if GPS information is being displayed, display operation of the GPS information is suspended or a display region is reduced. In this state, the user voice inputs a dial number of a party terminal, and further, voice inputs outgoing call.

As described above, when outgoing call operation is made in the car navigation device, control data for notifying an outgoing call number is transmitted from the BT radio section to the mobile telephone set MS via the BT radio link. When the mobile telephone set MS receives control data for notifying such outgoing call from the car navigation device via the BT radio link, the W-CDMA radio section transmits outgoing call data to the mobile communication network. In contrast, when an incoming call response operation is made in the mobile telephone set at the called party side, a connection between the mobile communication network and the mobile telephone set MS is established by a radio link using the W-CDMA scheme. Then, the mobile telephone set MS enables television telephone communication with a party terminal.

In this communication state, transfer operation of speech data between the mobile telephone set MS and the car navigation device is similar to a case during incoming call described previously.

As described above, in the second embodiment, in the case where video data for television telephone communication is displayed by utilizing a display section of the car navigation device, it is determined whether or not GPS information is being displayed. If GPS information is being displayed, display operation of the GPS information is suspended or the display region is reduced. In this state, video data for television telephone communication is displayed.

Therefore, video data for television telephone communication can be displayed without causing any problem while using a display section of the car navigation device.

In the case where a GPS information display region is reduced, a full screen display region of the display section is divided into two sections so that GPS information may be reduced to be displayed in one of these divided display regions. By doing this, video data for television telephone communication can be displayed in the other display region.

In addition, instead of reducing the GPS information display region, video data for television telephone communication may be displayed to be superimposed on part of the GPS information. This can be accomplished by using a picture-in-picture system or by using a video memory to composite GPS information and video data with each other.

(Other Embodiments)

The present invention is not limited to each of these embodiments. For example, in the first embodiment, a description has been given by exemplifying a case of making hands-free communication. However, in the case where a camera 82 and a display section 83 are provided at the car audio device AS, television telephone communication of the hands-free system may be made by employing these camera 82 and display section 83.

In this case as well, for example, if data representing an operation state of the car audio device AS is already displayed at the display section 83 of the car audio device AS, the display of the display data may be suspended by a mute control or may be reduced in a manner similar to that in the second embodiment.

In addition, in the first embodiment, there has been described a case in which an echo canceller 5 required for hands-free communication is provided at the car audio device AS. However, in the case where the mobile telephone set MS itself comprises a hands-free communication function, an acoustic echo generated between the speaker 1 and the microphone 2 of the car audio device AS may be cancelled by employing the echo canceller provided at this mobile telephone set MS.

This makes it unnecessary to provide an echo canceller 5 for hands-free communication at the car audio device AS.

Further, it is possible to use, for another application, the result of authentication procedures executed when a BT radio link is established between the mobile telephone set MS and the car audio device AS. For example, as a result of the above authentication, in the case where the mobile telephone set MS requiring connection is not registered in advance, hands-free mode setting is rejected, and a command is assigned to an engine control circuit of the car CR, thereby restricting engine startup.

By doing this, the car CR can be safeguarded by utilizing a BT authentication function between the mobile telephone set MS and the car audio device AS.

In addition, in the first embodiment, there has been described a case in which the car audio device AS itself comprises the BT radio interface function and the hands-free communication function. The present invention is not limited to the case. An adapter device having the BT radio interface function and the hands-free communication function is provided, and this adapter device is connected to the car audio device AS so that the present invention may be achieved.

This makes it possible to utilize the existing car audio device AS intact.

The adapter device may be composed of its required minimum hardware for achieving the BT radio interface function and hands-free communication function, for example, and a memory card storing a program for controlling this hardware.

Further, in the first and second embodiments, there has been described a case in which a car mounted electronic device such as car audio device AS or car navigation device is defined as a master device of Bluetooth, and the mobile telephone set MS is defined as a slave device so as to establish and disconnect the BT radio link. However, the present invention is not limited to this case. The mobile telephone set MS is defined as a master device of Bluetooth, and the car mounted electronic device is defined as a slave device so as to establish and disconnect the BT radio link. In this case, a link establishing sequence is such that a master and a slave is switched to each other in the sequence shown in FIG. 4.

Further, in the first embodiment, a description has been given by exemplifying a case in which the car audio device AS is used as a car mounted electronic device; and in the second embodiment, a description has been given by exemplifying a case in which a car navigation device is used in the second embodiment. However, a car telephone device or an automatic running control unit or the like utilizing an ITS (Intelligent Transport System) may be used.

Furthermore, as a radio interface for making a connection between the car mounted electronic device and the mobile communication terminal, there can be used a radio interface employing a scheme used in a radio LAN such as IEEE 802.11 or another short distance radio data communication scheme called HomeRF.

Otherwise, with respect to the type or configuration of a mobile communication terminal or type of radio interface used for communication with a mobile communication network, various modifications are applicable without departing from the spirit of the present invention.

### Industrial Applicability

As has been described in detail, according to the present invention, there is provided a mobile communication terminal for use in connection to a car mounted electronic device, comprising information output means having at least one of a speaker or a display, or information input means having at least one of a microphone and a camera, the mobile communication terminal further comprising: first radio interface means for making radio communication with a mobile communication network via a first radio channel; second radio interface for making radio communication with a car mounted electronic device via a second radio channel using electric power smaller than the first radio channel; and first or second information data transfer control means. In the first information data transfer control means, reception information data received from the mobile communication network via the first radio channel is transferred to the car mounted electronic device via the second radio channel so as to be outputted from the information output means of the car mounted electronic device. On the other hand, in the second information data transfer control means, transmission information data inputted by information input means of the car mounted electronic device is received from the car mounted electronic device via the second radio channel so as to transmit the transmission information data to the mobile communication network via the first radio channel.

Therefore, according to the present invention, there can be provided a mobile communication terminal and car mounted electronic device capable of making hands-free mobile communication without requiring a specific car kit, whereby mobile communication in car can be made inexpensively and easily.

1. A mobile communication terminal communicatable with a car mounted electronic device, said mobile communication terminal comprising:
means for making radio communication with a mobile communication network via a first radio channel;
means for making radio communication with said car mounted electronic device via a second radio channel; and
information data transfer control means for transferring reception information data received from said mobile communication network via said first radio channel to said car mounted electronic device via said second radio channel, so that the reception information data is outputted from said car mounted electronic device.

2. The mobile communication terminal according to claim 1, further comprising an output operation control means for supplying an output operation limiting command to said car mounted electronic device via said second radio channel, so as to limit an output of information specific to said car mounted electronic device.

3. The mobile communication terminal according to claim 2, so as to display the reception information data, said output operation control means supplies the output operation command in order to suspends display operation of a second video data specific to said car mounted electronic device if, said information data transfer means transfers said reception information data containing a data to said car mounted electronic device.

4. The mobile communication terminal according to claim 2, wherein said output operation control means supplies the output operating command in order to reduce a display region where a data specific to said car mounted electronic device is displayed if, said information data transfer means transfers said reception information data containing a data to said car mounted electronic device.

5. The mobile communication terminal according to claim 1, further comprising
means for detecting an entrance into a radio communication area communicable with said car mounted electronic device via said second radio channel; and
means for making connection to said car mounted electronic device via a radio link caused by said second radio channel corresponding to the fact that the entry detecting means has detected the entrance into said radio communication area, enabling transfer of information data by said information data transfer means.

6. The mobile communication terminal according to claim 1, further comprising
means for detecting getting out from a radio communication area communicable with said car mounted electronic device via said second radio channel; and
means for disconnecting said second radio channel if said detecting means detects the terminal gets out from the radio communication area.

7. The mobile communication terminal according to claim 1, wherein said reception information data is transferred under Bluetooth system.

8. The mobile communication terminal according to claim 1, further comprising
means for receiving information data transmitted from the car mounted electronic device via said second radio channel; and means for transmitting said information data to said mobile communication network via said first radio channel.

9. The mobile communication terminal according to claim 8, further comprising output operation control means for, supplying an output operation limiting command to the car mounted electronic device via said second radio channel, when information data containing first data is received from said car mounted electronic device, whereby display operation of second data specific to the car mounted electronic device is suspended at said car mounted electronic device.

10. The mobile communication terminal according to claim 8, further comprising output operation control means for supplying an output operation limiting command to the car mounted electronic device via said second radio channel, when said information data containing first data is received from said car mounted electronic device, whereby a region where the second data is displayed at said car mounted electronic device is reduce.

11. A car mounted electronic device to a mobile communication terminal, said car mounted electronic device comprising:
information output means for outputting information specific to the car mounted electronic device;
radio interface means for making radio communication with said mobile communication terminal via a radio channel; and
means for, receiving the information data transferred from said mobile communication terminal, and outputting the thus received information data from said information output means.

12. The car mounted electronic device according to claim 11, further comprising output operation control means for limiting an output of information specific to the car mounted electronic device at said information output means.

13. The car mounted electronic device according to claim 12, wherein, when information data containing first data is received from said mobile communication terminal, said output operation control means controls said information output means so as to suspend display operation of second data specific to the car mounted electronic device.

14. The car mounted electronic device according to claim 12, wherein, when information data containing first data is received from said mobile communication terminal, said output operation control means controls said information output means so as to reduce a region where the second data is displayed at output means.

15. The car mounted electronic device according to claim 11, further comprising
entry detecting means for detecting that said mobile communication terminal enters a communicable radio communication area by said radio channel;
authentication means for, in the case where the entry detecting means has detected entry of the mobile communication terminal into said radio communication area, making connection to said mobile communication terminal via the radio channel, thereby executing authentication procedures with the mobile communication terminal; and
vehicle operation control means for, in the case where it is determined by said authentication means that the mobile communication terminal is not registered in advance, disabling opening of a vehicle door or engine startup.

16. The car mounted electronic device according to claim 11, wherein said information data is transferred under Bluetooth system.

17. The car mounted electronic device according to claim 11, further comprising
means for inputting information data of the car mounted electronic device;
means for transmitting said outputted information data to said mobile communication terminal via the radio channel.

18. A mobile communication terminal connectable to a car audio device having a speaker and a microphone, said mobile communication terminal comprising:
means for making radio communication with a mobile communication network via a first radio channel;
means for making radio communication with said car audio device via a second radio channel using transmission power smaller than said first radio channel;
means for transferring reception audio data received from said mobile communication network via said first radio channel to said car audio device via said second radio channel, so that the reception audio data is outputted from said speaker of said car audio device;
means for receiving transmission audio data inputted by said microphone via said second radio channel; and means for transmitting the transmission audio data to the mobile communication network via said first radio channel.

19. A mobile communication terminal according to claim 18, wherein said reception audio data is transferred under Bluetooth system.

20. A mobile communication terminal communicatable with a car navigation device having a display, said mobile communication terminal comprising:
means for making radio communication with a mobile communication network via a first radio channel;
means for making radio communication with said car navigation device via a second radio channel; and
means for transferring reception data received from said mobile communication network via said first radio channel to said car navigation device via said second radio channel, thereby causing said display of the car navigation device to display the reception data.

21. The mobile communication terminal according to claim 20, wherein said reception data is transferred under Bluetooth system.

22. The mobile communication terminal according to claim 20, further comprising means for, supplying a display limiting command to said car navigation device via said second radio channel, so as to suspend display operation of information specific to said car navigation device when reception video data is transferred to said car navigation device to be displayed on the display.

23. The mobile communication terminal according to claim 20, further comprising means for supplying a display limiting command to said car navigation device via said second radio channel, so as to reduce a region where information specific to said car navigation device is displayed when reception video data is transferred to said car navigation device to be displayed on the display.
